(19) United States
(12) Patent Application Publication
(10) Pub. No.: US 2008/0046628 A1
(43) Pub. Date: Feb. 21, 2008

(54) MULTI-BUS TYPE MANAGEMENT MESSAGING METHOD AND APPARATUS

(76) Inventors: Mikal Hunsaker, El Dorado Hills, CA (US); Travis Schluessler, Hillsboro, OR (US); Thomas Slaight, Beaverton, OR (US); David Hines, Phoenix, AZ (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/618,372

(22) Filed: Dec. 29, 2006

Related U.S. Application Data
(60) Provisional application No. 60/839,401, filed on Aug. 21, 2006.

(51) Int. Cl. G06F 13/36

(52) U.S. Cl. 710/315

(57) ABSTRACT

A management controller configured to generate and transmit transport layer packets to send management messages to a plurality of recipients managed by the management controller, co-disposed on the same computing platform, is disclosed and described herein. The managed recipients may be coupled to the management controller via buses of different bus types. The management controller is configured to logically address the managed recipients, to automatically split a management message over multiple packets when constrained by data bandwidth of a bus of a particular bus type, or to appropriately format the transport layer packets for the different buses of different bus types.

### RELATED APPLICATION

This application is a non-provisional application of provisional application 60/839,401, entitled “Management Controller Message Protocol”, filed Aug. 21, 2006, and claims priority to the same.

### BACKGROUND

1. Technical Field

Embodiments of the present invention are related to the field of data processing, and in particular, to a management messaging method and apparatus for managing entities on buses of multiple bus types.

2. Description of Related Art

Most computing systems employ one or more buses to couple peripheral devices to the central processing units (also referred to simply as processors) to facilitate data exchanges between the peripheral devices and the processors. As computing technology continue to advance in recent years, the complexity of computing systems have likewise increased significantly, employing increasing number of processors, peripheral devices, and multiples buses to couple the peripheral devices to the processors. Examples of these buses include but are not limited to I²C, PCI, PCIe, SMBus and so forth. {I²C=Inter-integrated Circuit Bus, see I²C-Bus Specification, V2.1, January 2000; PCI=Peripheral Component Interconnect, see PCI Local Bus Specification, V2.2, December, 1998; PCIe=PCI Express, see PCIe Base Specification V1.1, 2002; SMBus=System Management Bus, see System Management Bus(SMBus) Specification V2, August 2000.}

Management controllers have been introduced to assist in the automated management of computing platforms. However prior art systems typically require a management controller to communicate with a managed device over a proprietary bus, e.g. Clink in the case of Intel's Manageability Engine.

### BRIEF DESCRIPTION OF THE DRAWINGS

FIG. 1 illustrates an overview of a managed system incorporated with teachings of the present invention, according to some embodiments.

FIG. 2 illustrates the managed system of FIG. 1 in further detail, according to some embodiments.

FIG. 3 illustrates selected operation flow of the primary management controller, according to some embodiments.

FIG. 4 illustrates a control packet format suitable for use by the management controllers to manage the managed entities, according to some embodiments;

FIG. 5 illustrates a capability discovery response packet format suitable for use by a managed entity to respond to a management controller, according to some embodiments;

FIG. 6 illustrates a management controller messaging packet suitable for use over a SMBus, according to some embodiments.

FIG. 7 illustrates a management controller messaging packet suitable for use over a PCIe-bus according to some embodiments.

FIG. 8 is a block diagram of an illustrative computing system suitable for use to practice the present invention, according to some embodiments.

### DETAILED DESCRIPTION OF ILLUSTRATIVE EMBODIMENTS

Embodiments of the invention include a management controller configured to manage managed devices co-located with the management controller on a computing platform. Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects.

For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one/various embodiment(s)” is used repeatedly. The phrase generally does not refer to the same embodiment; however, it may. The term “coupled” shall encompass a direct connection, an indirect connection or an indirect communication. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

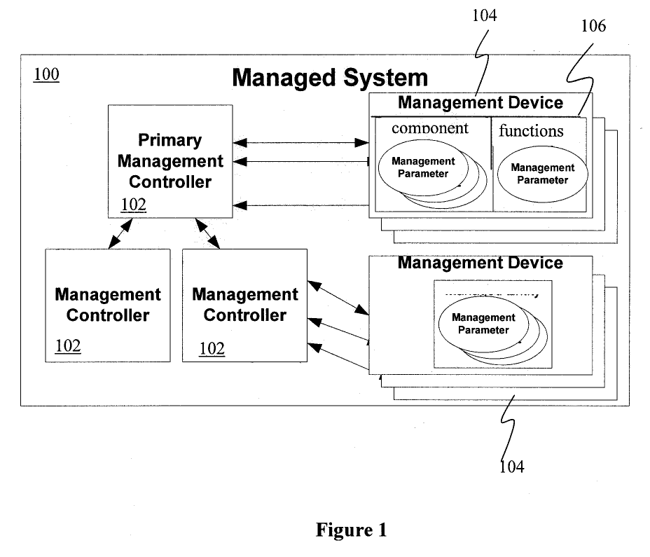

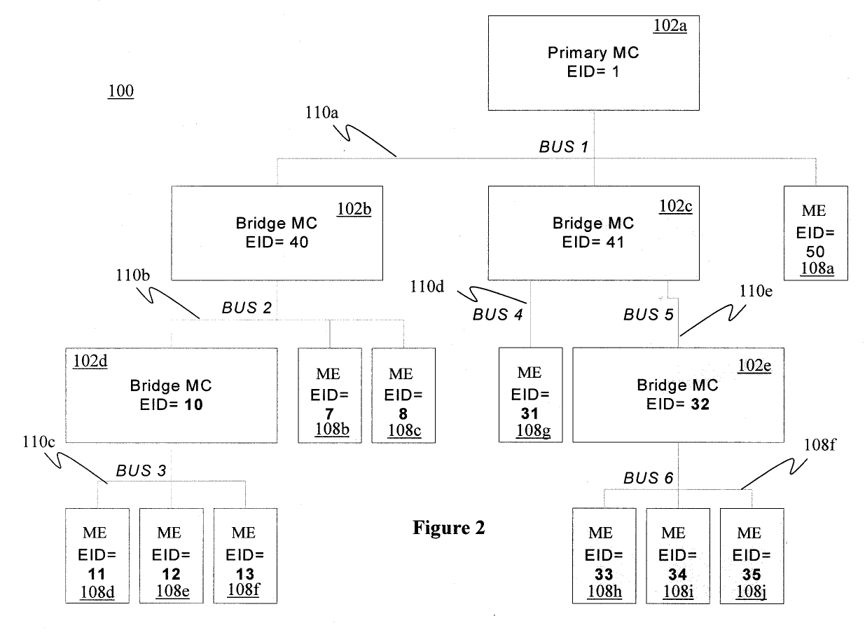

Referring now to FIG. 1, illustrated therein according to various embodiments, is a managed system 100 having a number of management controllers 102 and a number of managed devices 104 coupled to each other via one or more buses (illustrated in more detail in FIG. 2). Among management controllers 102, one operates as a primary management controller. As will be described in more detail below, management controllers 102 are incorporated with the teachings of the invention, such that, in addition to managed devices 104 themselves, management controllers 102 may manage a component or a function 106 within a managed device 104. Each of the managed devices 104 or components/functions 106 may have one or more management parameters. Examples of management devices 104 and management components/functions 106 include but are not limited to temperature sensors, fan speed sensors, power supplies, and so forth, and examples of management parameters include but are not limited to temperature, speed, voltage, on/off, link state, uncorrectable error count, device power state, and so forth.

Still referring to FIG. 1, management controllers 102, incorporated with the teachings of the invention, are configured to communicate with the managed devices 104 and components/functions 106 employing a management controller messaging protocol, appropriately formatting transport layer packets depending on the bus types of the buses coupling the managed devices to the management controller. As a result, management applications may be freed from having to be cognizant of the bus types of the buses, the managed entity reside. In turn, entity management may be more easily implemented on a computing platform with multiple entities coupled to management controllers 102 over multiple buses of multiple bus types; and development/maintenance cost to developers of management controllers may be reduced.

For ease of understanding, the remainder of this specification, including the claims, may collectively refer to managed devices 104 and/or managed components/functions 106 as managed entities or endpoints. Since managed entities/endpoints 104/106 are coupled to management controllers 102 via one or more buses, managed entities 104/106 may also be referred to as bus agents.

FIG. 2 illustrates various embodiments of managed system 100 of FIG. 1 in further details. For these embodiments, managed system 100 includes five management controllers (MC) 102a-102e, with management controller 102a operating as the primary management controller, and the other management controllers 102b-102e operating as the bridge management controllers. Managed system 100 further includes ten managed entities (ME) 108a-108j coupled to management controllers 102a-102e via buses 110a-110e as shown. Examples of buses 110a-110e include but are not limited SMBus and PCIe-bus.

Note that embodiments of the invention are not limited to the number of management controllers 102a-102e, managed entities 108a-108j and buses 110a-110e illustrated in FIG. 2. In other embodiments, the invention may be practiced with more or less management controllers 102a-102e, managed entities 108a-108j or buses 110a-110e.

Still referring to FIG. 2, as will be described in more detail, primary management controller 102a is configured to enumerate each bus on system initialization, and assign bus addresses to the managed entities (managed devices, and if applicable, to the managed components/functions disposed thereon), including physical and logical addresses. The latter is also referred to as a managed entity/endpoint identifier or simply, entity/endpoint identifier (EID). The physical address of a managed component/function is the physical address of the device on which the managed component/function is located. After enumeration and address assignment, primary management controller 102a discovers the capabilities and functions of the managed devices. In various embodiments, primary management controller 102a performs the enumeration, address assignment and capability discovery for all buses coupled to the primary management controller 102a directly or indirectly, one bus at a time. Thereafter, on completion, primary management controller 102a in cooperation with the other management controllers 102b-102e manages the managed entities employing the management controller messaging protocol of the invention, and appropriately formatting transport layer packets in accordance with the bus types of the buses coupling the managed entities to the management controllers 102a-102e.

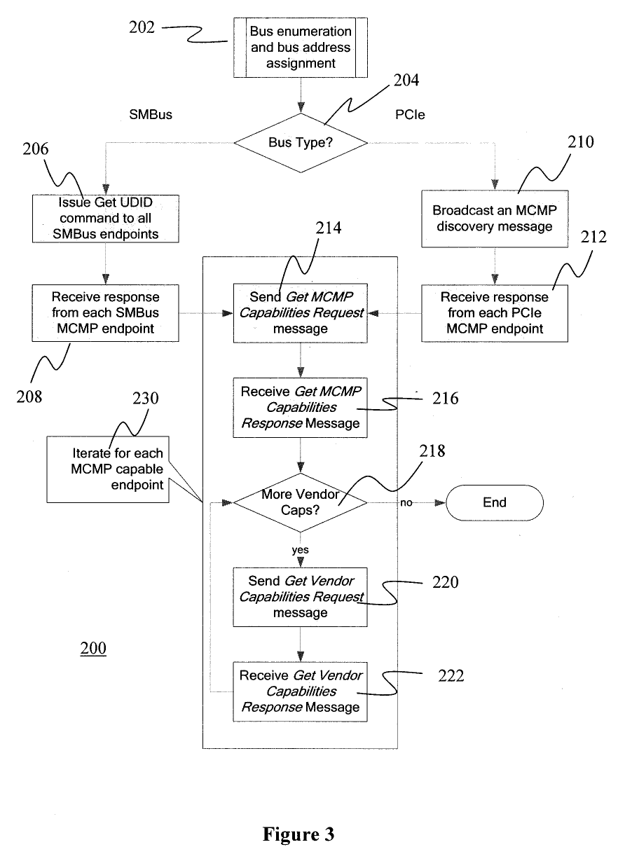

FIG. 3 illustrate the enumeration, address assignment, and capability discovery operation flow for a bus by the primary management controller in further detail, in accordance with various embodiments. As illustrated, at block 202, primary management controller 102a starts the enumeration and address assignment process for a bus. At block 204, primary management controller 102a determines the bus type of the bus. In various embodiments, the operation involves determining whether the bus is a SMBus or a PCIe-bus. In various embodiments, the determination may be performed by accessing a configuration repository or table of a computing platform.

For the embodiments, on determining that the bus is a SMBus, primary management controller 102a proceeds to enumerate the number of entities/endpoints endowed with the teachings of the present invention for the entities/endpoints to be managed by primary management controller 102a in accordance with the management controller messaging protocol (MCMP) of the invention, at block 206-208. For the embodiments, primary management controller 102a performs the enumeration by issuing the SMBus Get UDID command to all MCMP endpoints on the SMBus at block 206. At block 208, primary management controller 102a receives response from each management entities/endpoints endowed with the complementary teachings. Thereafter, primary management controller 102a assigns each responsive managed entity/endpoint with unique addresses.

Similarly, on determining that the bus is a PCI-e bus, primary management controller 102a proceeds to enumerate the number of entities/endpoints endowed with the teachings of the present invention for the entities/endpoints to be managed by primary management controller 102a in accordance with the management controller messaging protocol (MCMP) of the invention, at block 210-212. For the embodiments, primary management controller 102a performs the enumeration by broadcasting a MCMP discovery message on the PCIe-bus at block 210. At block 212, primary management controller 102a receives a response from each management entities/endpoints endowed with the complementary teachings. Thereafter, primary management controller 102a assigns each responsive managed entity/endpoint with unique addresses.

Thereafter, whether it is SMBus or PCIe-bus, primary management controller 102a proceeds to discover the capabilities of each managed entity/endpoint, block 230. At block 214, primary management controller 102a sends a Get MCMP capability request message to the managed endpoint. At block 216, primary management controller 102a receives a response to the request message. At block 218, determines whether the managed entity/endpoint has additional vendor provided capabilities. If so, primary management controller 102a sends a Get Vendor capability request message to the managed endpoint at block 210. At block 222, primary management controller 102a receives a response to the request message. Blocks 218-222 are repeated by primary management controller 102a until all Vendor capabilities have been discovered/learned.

Process 230 (including operations 214-222) is then repeated until the MCMP capabilities, and if applicable Vendor capabilities of all entities/endpoints of the bus have been discovered/learned.

In various embodiments, on completion of enumeration, address assignment, and capability discovery at initialization, the entity identifiers, their addresses, capabilities and so forth, are stored in a management controller messaging routing table (not shown).

In various embodiments, primary management controller 102a is also endowed to support dynamic assignment of addresses and capability discovery, to support hot swap and/or plug-n-play of managed devices. The addresses are assigned and the capabilities are discovered on detection of “plug in” of a managed device. On assignment and discovery, the management controller messaging routing table is dynamically updated.

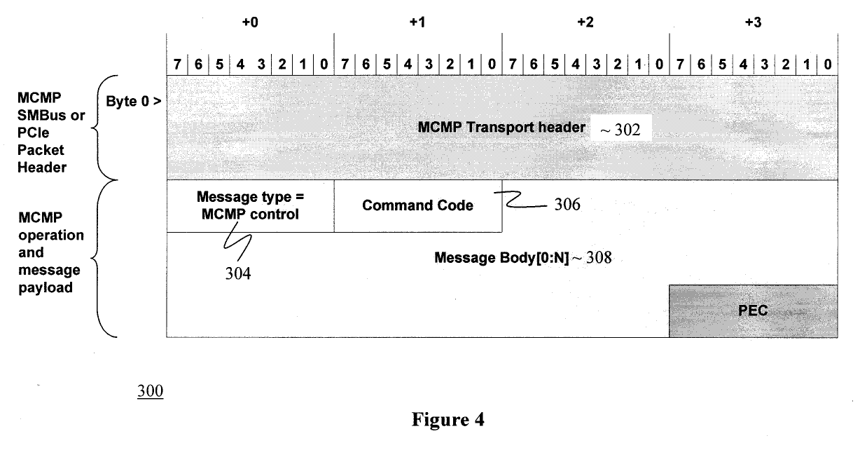

FIG. 4 illustrates a control packet format suitable for use by primary management controller 102a to enumerate and assign addresses to a managed entity, in accordance with various embodiments. For the embodiments, a control packet 300 includes transport header 302, a message type field 304 set to “MCMP Control, a command code field 306, and message body 308.

In various embodiments, command code 306 may be

| Command | Operation | |
|---|---|---|
| Code | Type | Detailed description |
| 00h | Reset | Reset the MCMP endpoint |
| 02h | Get MCMP | Discover an MCMP endpoint's supported data models |
| | Capabilities | and available capabilities |
| 03h | Get Vendor | Discover an MCMP endpoint's vendor specific MCMP |
| | defined | extensions and capabilities |
| | MCMP | |
| | Capabilities | |
| 04h | Set MCMP | Notify an endpoint as to what capabilities it is allowed to use |
| | Capabilities | in the current system |
| 05h | Endpoint ID | Management controller asks MCMP endpoints on how |
| | Assignment | many dynamic and static endpoint IDs they would like |
| 06h | Routing | Communicate routing information about MCMP |
| | information | endpoints |
| | update | |
| 07h | Get | Retrieve a per-device unique GUID associated with |
| | endpoint | the endpoint. |
| | GUID | |
| 08h | Get State | Retrieve dynamic MCMP state associated with an |
| | | endpoint such as assigned endpoint IDs and endpoint |
| | | ID pools |
| 09h | Endpoint | Message used to discover MCMP capable devices (in |
| | discovery | various embodiments, it is only used on PCIe buses) |
| 0Ah | State notify | Proactively notify a management controller of state |
| | | information regarding an MCMP endpoint. |

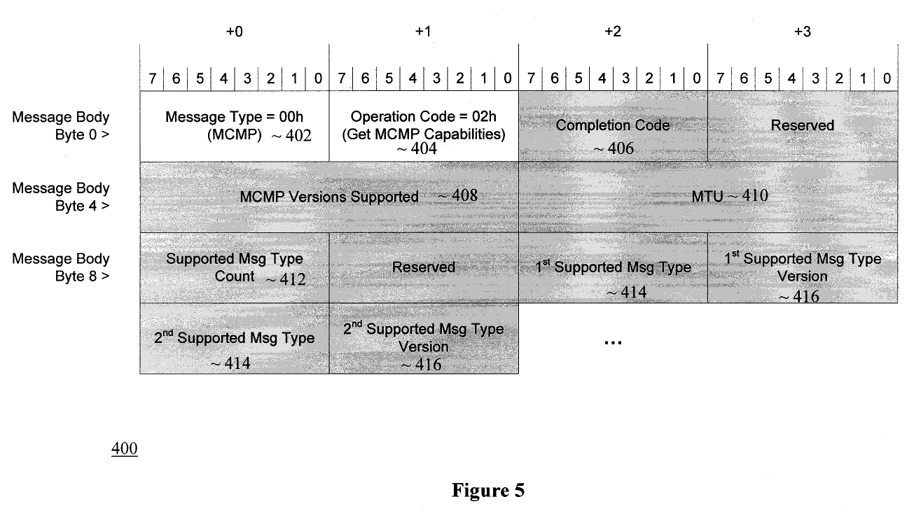

FIG. 5 illustrates a Get MCMP response packet format suitable for use by a managed entity to reply to a MCMP capability discovery packet, in accordance with various embodiments. For the embodiments, a response packet 400 includes a message type field 402, an operational code 404, a completion code 406, a version field 408, a MTU (maximum transfer unit) filed 410, a count field 412, and a number of pairs of message supported fields 414 and 416 as follows:

| | | |
|---|---|---|
| Message Type | Identifies this as an MCMP control message | 00h |
| | | (MCMP) |
| Operation Code | Get MCMP Capabilities command. | 02h |
| Completion | Indicates the success or failure of the | Variable |
| Code | operation. For failure, the nature of the | |
| | failure may be indicated as well. | |
| MCMP | This field is a bit field of flags indicating the | Variable |
| versions | different MCMP versions supported by the | |
| supported | endpoint. For example, if the endpoint | |
| | supported MCMP 1.0 the value of this field | |
| | would be ‘0001h’. | |
| MTU | The Maximum Transmission Unit for the | M |
| | endpoint. This is an indication of buffering | |
| | capabilities in the endpoint rather than | |
| | limitations of the medium used to send | |
| | messages. | |
| MCMP | Specifies the MCMP version to which the | 00h |
| Version | responding endpoint was implemented. | |
| Supported | The number of MCMP message types | Various |
| Message Types | supported by this endpoint. | |
| count | | |
| Nth Supported | Each ‘Supported Message Type’ field | Bit fields |
| Message Type | represents a single message type supported | |
| | by an endpoint. | |

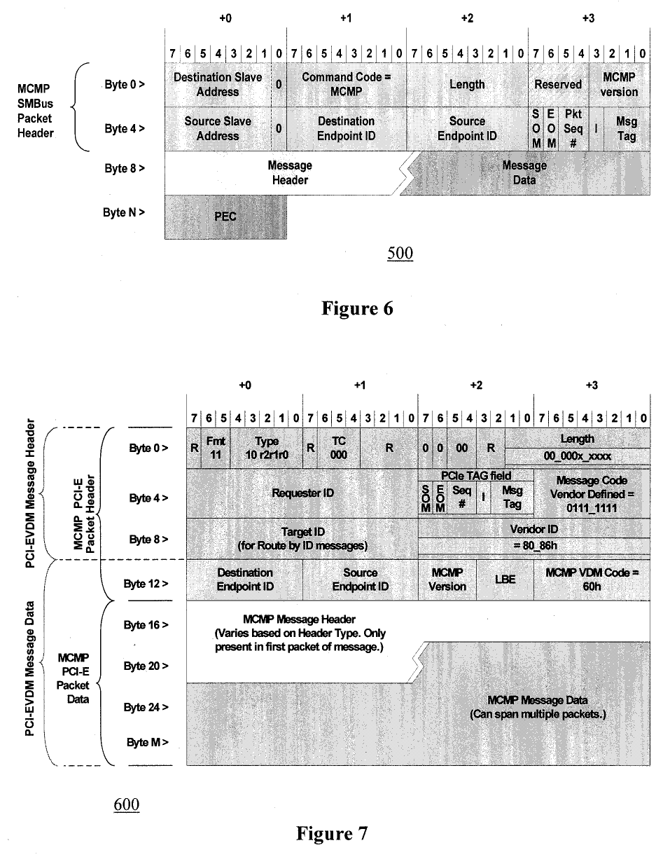

FIGS. 6 and 7 illustrate management message packet formats suitable for use by the management controllers over a SMBus and a PCIe-bus respectively, according to the various embodiments.

In various embodiments, the fields of a SMBus management message packet are defined as follows:

| | Block Write | |
|---|---|---|
| Byte | Field(s) | Description |
| 0 | Slave | SMBus Destination Slave Address[7:1]: The slave |
| | Address | address of the target device for the local SMBus link |
| | Wr | [0]: R/W# bit. In various embodiments, set to ‘0’ for all |
| | | MCMP messages. In other words, for these |
| | | embodiments, all MCMP messages are writes |
| 1 | Command | Command Code: SMBus Command Code |
| | Code | In various embodiments, all MCMP over SMBus |
| | | messages use a command code of 10h. |
| 2 | Byte Count | Length: SMBus Block Write command length of this packet. |
| | | In various embodiments, MCMP devices support Block |
| | | Write lengths of 72 bytes, which allows for 64 bytes of |
| | | message header/data/trailer plus 8 bytes of packet |
| | | header. |
| | | Note: The SMBus 2.0 specification limits the Block |
| | | Write length to 32 bytes. MCMP block writes with |
| | | lengths >32 bytes are only permitted when the system |
| | | knows that all devices on that SMBus segment/link |
| | | support block writes of >32 B. |
| | | This is not necessarily the length of the entire MCMP |
| | | message, since the message may be made up of |
| | | multiple chained packets. |
| 3 | Data Byte 1 | Reserved [7:4]: This nibble is reserved. |
| | | MCMP version[3:0]: |
| | | “0000”: For version 1.0, e.g. |
| 4 | Data Byte 2 | SMBus Source Slave Address [7:1]: For the local |
| | | SMBus link, the slave address of the source device |
| | | [0]: SMBus Write#/Read data direction bit. Since MCMP on |
| | | SMBus only uses SMBus Block Write Protocol |
| | | transactions, this bit must always be set to 0 b, per |
| | | [SMBUS]. |
| 5 | Data Byte 3 | Destination Endpoint ID: ID of the Endpoint to receive |
| | | the MCMP Packet |
| | | In various embodiments, a few Endpoint ID values are reserved |
| | | for specific routing: |
| | | 0 = Local Bus Address Only. The message is |
| | | terminated by the MCMP Endpoint functionality based |
| | | on the physical address of the MCMP interface on the |
| | | particular physical bus segment. For example, on |
| | | SMBus the message would be routed based on the |
| | | Slave Address only. This enables functions such as |
| | | allowing an MCMP Bus Segment Owner to assign an |
| | | Endpoint ID to a device using MCMP Commands before |
| | | the device has a unique Endpoint ID. |
| | | 1 = Reserved for “Primary Management Controller”. |
| | | This is a ‘well known ID’ that is reserved for |
| | | accessing a centralized function that supports or |
| | | configures MCMP communication. |
| | | 2 = Reserved for bus type specific broadcast (Unused |
| | | on SMBus) |
| | | 3–7 Reserved for future definition |
| 6 | Data Byte 4 | Source Endpoint ID: The Endpoint ID of the originator |
| | | of the MCMP Packet. |
| 7 | Data Byte 5 | SOM [7]: Start Of Message: Set to ‘1’ if this packet is |
| | | the first packet of a message |
| | | EOM [6]: End Of Message: Set to ‘1’ if this packet is the |
| | | last packet of a message |
| | | Packet Sequence Number [5:4]: For messages that |
| | | span multiple packets, the packet sequence number |
| | | increments on each successive packet. This allows the |
| | | receiver to detect up to three successive missing |
| | | packets between the Start and End of Message. |
| | | Though the Packet Sequence Number can be any value |
| | | if the Start Of Message bit is set it is recommended that |
| | | it is an increment from the prior packet with an End Of |
| | | Message bit set. After the Start Of Message packet, the |
| | | Packet Sequence Number must increment modulo 4 for |
| | | any subsequent packet up through the packet |
| | | containing the End Of Message. |
| | | I [3]: Initiator. The Initiator bit together with the Endpoint |
| | | ID identify the packets of a particular MCMP Message |
| | | for the purpose of MCMP Message assembly at the |
| | | Endpoint. Depending on the Message Type, a given |
| | | Endpoint ID MAY support receiving and assembling two, |
| | | simultaneously interleaved, streams of MCMP Packets - |
| | | one for Initiator bit = 1, the other for Initiator bit = 0. The |
| | | Message Tag field is generated and tracked |
| | | independently for each value of the initiator bit. |
| | | Typically, MCMP messages types overlay this bit with |
| | | additional meaning, by using it to differentiate between |
| | | ‘request’ messages and ‘response’ messages. |
| | | Message Tag [2:0]: Field that, along with the Source |
| | | and Destination Endpoint IDs and the Initiator field, |
| | | identifies a unique Message at the MCMP Transport |
| | | level. Whether other elements, such as portions of the |
| | | MCMP Message Data field, are also used for uniquely |
| | | identifying instances of a message is dependent on the |
| | | Message Type. |
| | | The usage of the Message Tag field for handling |
| | | elements such as message retries is also Message |
| | | Type dependent. For Request Messages that require a |
| | | Response, the Message ID must be unique for all |
| | | outstanding messages. |
| | | For Request Messages that do not require a response, |
| | | the Message Tag can be set to any value. In various |
| | | embodiments, it is required that the Message Tag |
| | | increment, module 8, for each subsequent message to |
| | | assist with error handling associated with lost or |
| | | misrouted packets. |
| | | For Response messages, the Message Tag that was |
| | | sent with the Request is returned in the corresponding |
| | | Response. |
| | | A source endpoint is allowed to interleave packets from |
| | | multiple messages to the same destination endpoint |
| | | concurrently, provided that each of the messages has a |
| | | unique Message ID. |
| | | For messages that are split up into multiple packets, the |
| | | Initiator and Message Tag bits remain the same for all |
| | | packets From the Start of Message through the End Of |
| | | Message. |
| 8 | Data Byte 6 | Message Header and Data: These fields are defined in |
| through | through Data | chapter 4. |
| N-1 | Byte M | |
| N | PEC | Packet Error Code (PEC): The Packet Error Code as |
| | | defined in the SMBus 2.0 specification. All MCMP |
| | | transactions include a PEC byte and must be |
| | | transmitted by the source and checked by the |
| | | destination. |

Thus, for these embodiments, a SMBus packet is routed in accordance with the destination endpoint specified in data byte 3, allowing managed endpoints to be components or functions located on bus agents, and not limiting them to managed devices only.

With data byte 5, more specifically, with the Start of Message (SOM) bit, the End of Message (EOM) bit, and Packet Sequence Number bits, a management controller or a managed endpoint may automatically split a management message over a number of SMBus packets. Similarly, the recipients will examine these data bits, and use them to guide in the re-assembly of the management message. The Initiator bit is employed to denote whether the management controller or the managed endpoint is the owner of the meaning of a message tag used to facilitate an exchange of a management message between a management controller and a managed endpoint.

In various embodiments, a bridge management controller may also be endowed to modify the SMBus Destination Slave Address (Byte 1) in accordance with the Destination Endpoint address to facilitate forwarding of a SMBus packet. Resultantly, for these embodiments, the bridge management controller acts effectively as a SMBus bridge, enabling extension of a SMBus (not possible under the prior art before).

In various embodiments, the fields of a PCIe-bus management message packet are defined as follows:

| Byte | Description |
|---|---|
| 0 | Fmt [7:6]: Set to “11” to indicate 4 DW header with Data. All MCMP |
| | over PCI Express messages have at least one DW of data. |
| | Type [4:3]: Set to “10” to indicate a Message |
| | Type [2:0]: r2r1r0 Routing Fields |
| | 000: Route to Root Complex |
| | 010: Route by ID |
| | 011: Broadcast from Root Complex |
| | All other routing fields are not supported for MCMP. |
| 1 | TC [6:4]: Traffic Class. Set to “000” for all MCMP VDM |
| 2 | TD [7]: TLP Digest - Set to 0 for all MCMP VDM |
| | EP [6]: Error Present - Set to 0 for all MCMP VDM |
| | Attr [5:4]: Attributes - Set to 00 for all MCMP VDM |
| 3 | Length: Length of the data in DWORDS. Legal values can be between 1–16 |
| | DWORDS (1 byte to 64 bytes) |
| 5:4 | Requester ID. Bus/Device/Function number of the managed endpoint |
| | sending the message. |
| 6 | SOM [7]: Start Of Message: Set to ‘1’ if this packet is the start of a |
| | message |
| | EOM [6]: End Of Message: Set to ‘1’ if this packet is the end of a |
| | message |
| | Packet Sequence Number [5:4]: For messages that span multiple |
| | packets, the packet sequence number increments on each successive |
| | packet. This allows the receiver to detect up to 4 missing packets |
| | between the Start and End of Message. Though the Packet Sequence |
| | Number can be any value if the Start Of Message bit is set it is |
| | recommended that it is an increment from the prior packet with an End |
| | Of Message bit set. After the Start Of Message packet, the Packet |
| | Sequence Number must increment modulo 4 for any subsequent |
| | packet up through the packet containing the End Of Message. |
| | I [3]: Initiator. Set to ‘1’ if the Message Tag contains a value determined |
| | by the initiator, set to ‘0’ if the Message Tag contains a value returned |
| | as a responder. |
| | Message Tag [2:0]: Field that, along with the Source Endpoint ID and |
| | the Initiator field, identifies a unique Message ID. |
| | For Request Messages that require a Response, the Message ID must |
| | be unique for all outstanding messages. |
| | For Request Messages that do not require a response, the Message |
| | Tag can be set to any value. In various embodiments, it is required that |
| | the Message Tag increment, modulo 8, for each subsequent message |
| | to assist with error handling associated with lost or misrouted packets. |
| | For Response messages, the Message Tag sent with the Request is |
| | returned in the Response. |
| | A source endpoint is allowed to interleave packets from multiple |
| | messages to the same destination endpoint concurrently, provided that |
| | each of the messages has a unique Message ID. |
| | For messages that are split up into multiple packets, the Initiator and |
| | Message Tag bits remain the same for all packets From the Start of |
| | Message through the End Of Message. |
| 7 | Message Code: Set to 0111 1111 to indicate a Type 1 Vendor Defined |
| | Message |
| 9:8 | Target ID: For Route By ID Messages, this is the bus/device/function |
| | number of the Target Endpoint |
| | This field is ignored for Broadcast and Route to Root Complex |
| | messages |
| 11:10 | Vendor ID: Set to 8086h for Intel Vendor Defined Messages |
| 12 | Destination Endpoint ID: The unique ID on the system of the |
| | destination |
| | A few Endpoint ID values will be reserved for specific routing: |
| | 0 = Local Bus/Link only - Terminate at Receiver |
| | 1 = Route to Primary Management Controller |
| | 2 = Broadcast from the PCI express Bus Segment Owner (BSO) |
| | 3–7 Reserved for future definition |
| 13 | Source Endpoint ID. The system-wide unique ID of the endpoint |
| 14 | MCMP version [7:4]: |
| | “0001”: For all MCMP devices compliant to the MCMP 1.0 |
| | specification |
| | All Other settings: Reserved to support future packet header field |
| | expansion and/or header version. An example of a possible future |
| | packet header would be one that supported a 2 byte Endpoint ID. |
| | LBE [3:0]: Last DW Byte Enable. Indicates the valid bytes in the last |
| | DW (‘1’ = valid, ‘0’ = invalid). Legal values include 1111, 0111, 0011 |
| | and 0001 |
| | Must be set to 1111 if the EOM field is not ‘1’. |
| 15 | MCMP Command Code: Identifies this MCMP messages from other |
| | Intel Vendor Defined Messages. Set to 60h. |
| 16 | Message Header and Data. |
| through N | |

For these embodiments, byte 12 is employed to carry the destination endpoint (logical) address of the receiving endpoint; and byte 6 contains the SOM, EOM, Packet sequence, and Initiator information earlier described in association with the SMBus embodiments.

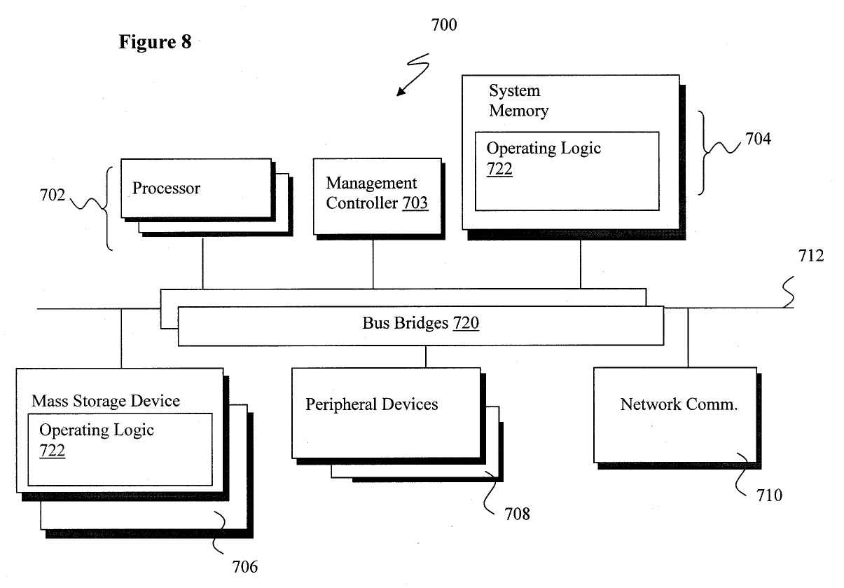

FIG. 8 illustrates an example computer system suitable for practicing the invention, in accordance with various embodiments. As shown, computing system 700 includes one or more processors 702, management controller 703 and system memory 704. Additionally, computing system 700 includes mass storage devices 706 (such as diskette, hard drive, CDROM and so forth), peripheral devices 708 (such as keyboard, cursor control, temperature sensors, power supplies, and so forth) and communication interfaces 710 (such as network interface cards, modems and so forth). The elements are coupled to each other via a system of buses 712, bridged by one or more bus bridges 720.

Each of these elements performs its conventional functions known in the art. In particular, system memory 704 and mass storage 706 may be employed to store a working copy and a permanent copy of the programming instructions implementing various system services and applications, collectively denoted as instructions 722. The various modules may be implemented via assembler instructions supported by processor(s) 702 or high level languages, such as C, that can be compiled into such instructions. The permanent copy of the programming instructions may be placed into permanent storage 706 in the factory, or in the field, through, for example, a distribution medium (not shown), such as a compact disc (CD), or through communication interface 710 (from a distribution server (not shown)). A distribution CD may include all or portions of the implementing instructions.

Management controller 703 may be endowed with the teachings of the present invention described earlier for primary management controller 104a. One or more bus bridges 720 may be endowed with the teachings of the present invention described earlier for other management controllers 104b-104e. One or more peripheral devices 708 may be endowed with the teachings of the present invention described earlier for managed endpoints 108a-108j.

In various embodiments, management controllers 703, bus bridges 720 and peripheral devices 708 are endowed with circuitry and/or firmware to practice the teachings of the invention at the transport layer. Management controllers 703, bus bridges 720 and peripheral devices 708 further include circuitry for performing physical layer signaling of the transport layer packets.

The constitution of these elements 702-712 are known, and accordingly will not be further described.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is manifestly intended that this invention be limited only by the claims and the equivalents thereof.

1. A management apparatus comprising:
a transport layer configured to generate one or more transport layer packets to selectively transmit management messages to recipients located on a computing platform on which the management apparatus is disposed, the recipients being managed by the management apparatus and coupled to the management apparatus via one or more buses of the computing platform, the transport layer generating the one or more transport layer packets in accordance with a management messaging protocol, and supporting at least two bus types, appropriately formatting the one or more transport layer packets for the one or more buses in accordance with their bus type or types; and
a physical layer coupled to the transport layer to signal to transmit the one or more transport layer packets to the managed recipients.

2. The apparatus of claim 1, wherein each of the one or more transport layer packets comprises one or more bits to indicate whether the transport layer packet is a start, a continuing or an end of a management message.

3. The apparatus of claim 2, wherein the one or more bits comprise a first bit and a second bit, with a first setting of the first bit indicating the transport layer packet is a start of the management message, a second setting of the second bit indicating the transport layer packet is an end of the management message, and a complement of the first and second settings to indicate the transport layer packet is a continuing of the management message.

4. The apparatus of claim 1, wherein each of the one or more transport layer packets comprises at least a logical address of a bus agent, the bus agent being either the managed recipient, or having the managed recipient located thereon.

5. The apparatus of claim 4, wherein the bus agent is a selected of a SMBus bus agent or a PCI-bus bus agent.

6. The apparatus of claim 4, wherein the transport layer packet further comprises a physical address of the bus agent.

7. The apparatus of claim 4, wherein the transport layer packet further comprises at least a selected one of a logical address or a physical address of the management apparatus.

8. The apparatus of claim 1, wherein the transport layer is further configured to assign bus addresses to bus agents of the one or more buses, supporting at least two bus types.

9. The apparatus of claim 1, wherein the transport layer is further configured to discover capability or configuration of bus agents of at least one of the one or more buses, if the at least one bus is of a particular bus type.

10. A device management messaging method, comprising:
receiving form a management controller, by a managed recipient, a transport layer packet transmitting at least a portion of a management message from the management controller to the managed recipient, the transport layer packet having a logical address corresponding to the managed recipient, and one or more bits to indicate whether the transport layer packet is a start, a continuing, or an end of the management message, and the management controller and the managed recipient are co-located on a same computing platform; and
examining the one or more bits by the managed recipient to determine whether the transport layer packet is a start, a continuing, or an end of the management message.

11. The method of claim 10, wherein the one or more bits comprise a first bit and a second bit, with a first setting of the first bit indicating the transport layer packet is a start of the management message, a second setting of the second bit indicating the transport layer packet is an end of the management message, and a complement of the first and second settings to indicate the transport layer packet is a continuing of the management message.

12. The method of claim 10, wherein the managed recipient is a bus agent of the computing platform or located on a bus agent of the computing platform.

13. The method of claim 12, wherein the transport layer packet comprises the logical address of the managed recipient and a physical address of the bus agent.

14. The method of claim 10, wherein the transport layer packet comprises the logical address of the managed recipient and at least a selected one of a logical address or a physical address of the management controller.

15. The method of claim 10 further comprising receiving bus address assignment from the management controller.

16. The method of claim 10, further comprising responding to capability or configuration discovery by the management controller.

17. A computing system, comprising:
a processor;
an input device coupled to the processor;
a first bus coupled to the processor, the first bus being of a first bus type;
a second bus coupled to the processor, the second bus being of a second bus type different from the first bus type;
a first bus agent coupled to the first bus;
a second bus agent coupled to the second bus; and
a management controller coupled to the first bus and to the second bus, the management controller being configured to generate a plurality of transport layer packets to selectively transmit a plurality of management messages to the first and second bus agents in accordance with a common management messaging protocol, the management controller appropriately formatting the transport layer packets for the first and second bus agents in accordance with the first and second bus types.

18. The computing system of claim 17, wherein the transport packets destined for the first or the second bus agent have first and second different formats respectively.

19. The computing apparatus of claim 17, wherein the first and the second buses are SMBus and PCI-bus respectively, and the first and second bus agents are SMBus bus agent and PCI-bus bus agent.

20. The computing system of claim 17, wherein at least some of the transport packets are destined for a managed recipient located on a selected one of the first or the second bus agent.

21. The computing system of claim 17, wherein each of the one or more transport layer packets comprises one or more bits to indicate whether the transport layer packet is a start, a continuing or an end of a management message.

22. The computing system of claim 21, further comprising another management controller, similarly constituted as the management controller, coupling the management controller to at least one of the first or second bus.

23. An article comprising a machine-readable medium that contains instructions, which when executed by a device, enables the device to receive a SMBus packet having a destination slave address, and modify the destination slave address to facilitate routing of the SMBus packet to a SMBus agent, the SMBus packet transmitting at least a portion of a management message from a management controller to a managed recipient, the device coupling the management controller to a SMBus to which the SMBus agent is coupled, the device, the management controller, the SMBus agent and the SMBus being of a same computing platform, the managed recipient being either the SMBus agent or located on the SMBus agent, the SMBus packet being a transport layer packet generated by the management controller in accordance with a management messaging protocol that is independent of bus types, and appropriated formatted by the management controller for routing over the SMBus.

24. The article of claim 23, wherein each of the transport layer packets further comprises one or more bits to indicate whether the transport layer packet is a start, a continuing or an end of a management message.

25. The article of claim 23, wherein each of the transport layer packets further comprises a logical address of the managed recipient.
